(19) United States
(12) Patent Application Publication
(10) Pub. No.: US 2026/0217879 A1
(43) Pub. Date: Jul. 30, 2026

(54) COPOLYMERS OF ETHYLENE AND 1,3-BUTADIENE

(71) Applicant: Compagnie Generale Des Etablissements Michelin, Clermont-Ferrand (FR)

(72) Inventors: Robert NGO, Clermont-Ferrand (FR); Julien THUILLIEZ, Clermont-Ferrand (FR); Thibaut SOUCHARD, Clermont-Ferrand (FR)

(73) Assignee: Compagnie Generale Des Etablissements Michelin, Clermont-Ferrand (FR)

(21) Appl. No.: 18/721,528

(22) PCT Filed: Dec. 8, 2022
(86) PCT No.: PCT/EP2022/084960

§ 371 Date: Jun. 18, 2024

(30) Foreign Application Priority Data
Dec. 21, 2021 (FR) FR2114101

(51) Int. Cl. C08F 210/02; C10M 119/02; C10N 40/25

(52) U.S. Cl. CPC C08F 210/02; C10M 119/02; C08F 2800/10; C10M 2205/066; C10N 2040/25

(57) ABSTRACT

A copolymer of ethylene and of 1,3-butadiene which contains ethylene units, butadiene units and 1,2-cyclohexane units and which exhibits a number-average molar mass of greater than 10 000 g/mol is provided. The molar content of ethylene units in the copolymer is greater than 90% and less than or equal to 97%, and the molar content of 1,2-cyclohexane units in the copolymer is greater than 1%. The molar contents is calculated with respect to the total number of moles of ethylene, butadiene and 1,2-cyclohexane units. Such a copolymer can be used as thickener in engine lubricating compositions.

### CROSS REFERENCE TO RELATED APPLICATIONS

This U.S. patent application is a national phase entry of PCT Patent Application No. PCT/EP2022/084960, filed Dec. 8, 2022, which claims priority to French Patent Application No. FR2114101, filed Dec. 21, 2021, the entire contents of which are incorporated herein by reference in their entirety.

### BACKGROUND

### 1. Technical Field

The field of the present invention is that of copolymers of ethylene and of 1,3-butadiene intended to be used in engine oils as additives for improving the high temperature performance of engine oils.

### 2. Related Art

Engine oils, which are lubricating compositions containing mineral base oils, are used in an engine to minimize, under cold conditions, the energy losses caused by frictional actions in the engine and to maintain, under hot conditions, a continuous film of lubricant on the lubricated components of the engine. It is important for the viscosity of the lubricating composition to decrease as little as possible during operation under hot conditions in order to avoid breaking the lubricating film.

Mineral base oils represent a major constituent of the lubricating compositions which are engine oils. The viscosity of a mineral base oil decreases with an increase in the temperature and increases with a decrease in the temperature. It follows that the viscosity of a lubricating composition containing predominantly a mineral base oil also experiences a variation in its viscosity with the temperature.

In order to weaken the effect of a rise in temperature on the viscosity of a lubricating composition, it is known to add additives to a mineral base oil. These additives have a role of thickening the lubricating composition when the temperature increases in order to partially remedy the drop in the viscosity recorded under hot conditions. They generally increase the high temperature viscosity in order to counter the decrease in viscosity of the mineral base oil. These thickening additives are generally polymers. The two main families of polymers marketed as such are polymers having an ester function, such as poly(meth)acrylates, and hydrocarbon polymers, such as polyisobutylenes, copolymers of ethylene and of propylene, also known as OCPs, hydrogenated copolymers of diene and of styrene, and also hydrogenated polydienes.

### SUMMARY

It has discovered that copolymers of ethylene and of 1,3-butadiene can increase the high temperature viscosity of the base oils.

Thus, a first subject-matter of the invention is a copolymer of ethylene and of 1,3-butadiene which contains ethylene units, butadiene units and 1,2-cyclohexane units and which exhibits a number-average molar mass of greater than 10 000 g/mol, the molar content of ethylene units in the copolymer being greater than 90% and less than or equal to 97%, the molar content of 1,2-cyclohexane units in the copolymer being greater than 1%, the molar contents being calculated with respect to the total number of moles of ethylene, butadiene and 1,2-cyclohexane units.

### DETAILED DESCRIPTION

Any interval of values denoted by the expression “between a and b” represents the range of values greater than “a” and less than “b” (that is to say, limits “a” and “b” excluded), whereas any interval of values denoted by the expression “from a to b” means the range of values extending from “a” up to “b” (that is to say, including the strict limits “a” and “b”).

The compounds mentioned in the description can be of fossil origin or be biobased. In the latter case, they can, partially or completely, result from biomass or be obtained from renewable starting materials resulting from biomass. In the same way, the compounds mentioned can also originate from the recycling of pre-used materials, that is to say that they can, partially or completely, result from a recycling process, or else be obtained from starting materials themselves resulting from a recycling process.

The copolymer in accordance with the invention has the essential characteristic of being a copolymer of ethylene and of 1,3-butadiene, which implies that the monomer units of the copolymer are those resulting from the copolymerization of ethylene and of 1,3-butadiene.

The copolymer thus contains ethylene units and butadiene units. In a known way, an ethylene unit is a monomer unit with the pattern —(CH₂—CH₂)—. In an also known way, a butadiene unit is a monomer unit with the pattern —CH₂—CH(CH═CH₂)— or —CH₂—CH═CH—CH₂—, according to whether the 1,3-butadiene monomer is inserted into the polymer chain during the polymerization reaction by a 1,2- or 1,4-addition. The copolymer also contains 1,2-cyclohexane units. The presence of these saturated 6-membered cyclic hydrocarbon moieties in the copolymer results from a very particular insertion of ethylene and of 1,3-butadiene during their copolymerization, as is described, for example, in the document WO 2007054224. A 1,2-cyclohexane unit corresponds to the formula (I).

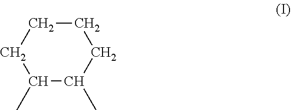

In the present invention, the molar contents of a unit in the copolymer in accordance with the invention are calculated with respect to the total number of moles of ethylene, butadiene and 1,2-cyclohexane units present in the copolymer.

In the copolymer in accordance with the invention, the molar content of ethylene units is greater than 90% and less than or equal to 97% and the molar content of 1,2-cyclohexane units is greater than 1%.

Preferably, the molar content of ethylene units in the copolymer in accordance with the invention is from 92% to 97%. More preferably, the molar content of ethylene units in the copolymer in accordance with the invention is from 92% to 96%.

According to a particular embodiment of the invention, the molar content of ethylene units in the copolymer is from 92% to 95%.

Preferably, the molar content of 1,2-cyclohexane units in the copolymer in accordance with the invention is greater than or equal to 2%. Preferably, the molar content of 1,2-cyclohexane units in the copolymer in accordance with the invention is less than 4%.

According to a preferential embodiment of the invention, the molar content of 1,2-cyclohexane units in the copolymer in accordance with the invention is greater than 1% and less than 4%.

According to a particularly preferential embodiment of the invention, the molar content of 1,2-cyclohexane units in the copolymer in accordance with the invention is greater than or equal to 2% and less than 4%.

Preferably, the molar content of butadiene units in the copolymer in accordance with the invention is greater than 1%, preferentially greater than or equal to 2%. According to any one of the embodiments of the invention, the molar content of butadiene units in the copolymer in accordance with the invention is preferentially less than 5%.

Preferably, more than 30 mol % of the butadiene units in the copolymer in accordance with the invention are 1,2-units of formula —CH₂—CH(CH═CH₂)—. When the copolymer contains 1,4-units of formula —CH₂—CH═CH—CH₂—, preferentially more than 50 mol %, more preferentially more than 80 mol %, of the 1,4-units are of trans configuration. According to any one of the embodiments of the invention, the copolymer in accordance with the invention preferentially contains 1,2-units of formula —CH₂—CH(CH═CH₂)— and 1,4-units of formula —CH₂—CH═CH—CH₂—.

The copolymer in accordance with the invention preferentially has a melting point of greater than or equal to 97° C., more preferentially a melting point of greater than 97° C.

Preferably, the copolymer has a degree of crystallinity of greater than 35%, preferentially of between 35% and 50%, more preferentially of between 35% and 45%.

According to one embodiment of the invention, the copolymer in accordance with the invention is a statistical copolymer.

The copolymer in accordance with the invention also has, as essential characteristic, a number-average molar mass, Mn, of greater than 10 000 g/mol. Preferably, the number-average molar mass of the copolymer in accordance with the invention is greater than 15 000 g/mol. More preferentially, the number-average molar mass of the copolymer in accordance with the invention is greater than 20 000 g/mol.

Preferably, the copolymer in accordance with the invention has a number-average molar mass of less than 200 000 g/mol, preferentially of less than or equal to 150 000 g/mol. More preferentially, the copolymer has a number-average molar mass of less than or equal to 130 000 g/mol, preferentially of less than or equal to 100 000 g/mol.

According to a particularly preferential embodiment of the invention, the copolymer in accordance with the invention has a number-average molar mass of greater than 10 000 g/mol and of less than 130 000 g/mol.

According to a particularly more preferential embodiment of the invention, the copolymer in accordance with the invention has a number-average molar mass of greater than 10 000 g/mol and of less than 100 000 g/mol.

The copolymer in accordance with the invention preferably exhibits a dispersity D, equal to Mw/Mn (Mw being the weight-average molar mass) of greater than 1 and of less than 5, preferentially of less than 4, more preferentially of less than 3. The values of Mn, Mw and are measured by size exclusion chromatography analysis with a polystyrene calibration.

The copolymer in accordance with the invention can be prepared by copolymerization of ethylene and of 1,3-butadiene in the presence of a catalytic system. The catalytic system comprises a metallocene of formula (II) and an organomagnesium compound

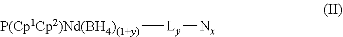

Cp¹ and Cp², which are identical or different, being selected from the group consisting of substituted fluorenyl groups and the unsubstituted fluorenyl group of formula C₁₃H₈,

P being a group bridging the two Cp¹ and Cp² groups and representing a ZR¹R² group, Z representing a silicon or carbon atom and R¹ and R², which are identical or different, each representing an alkyl group comprising from 1 to 20 carbon atoms, preferably a methyl,
y, which is an integer, being equal to or greater than 0,
x, which is or is not an integer, being equal to or greater than 0,
L representing an alkali metal selected from the group consisting of lithium, sodium and potassium,
N representing a molecule of an ether, preferably diethyl ether or tetrahydrofuran.

In the formula (II), the neodymium atom is connected to a ligand molecule consisting of the two Cp¹ and Cp² groups which are connected together by the bridge P. Preferably, the symbol P, denoted by the term bridge, corresponds to the formula ZR¹R², Z representing a silicon atom and R¹ and R², which are identical or different, representing an alkyl group comprising from 1 to 20 carbon atoms. More preferentially, the bridge P is of formula SiR¹R², R¹ and R² being identical and as defined above. More preferentially still, P corresponds to the formula SiMe₂.

Mention may be made, as substituted fluorenyl groups, of those substituted by alkyl radicals having from 1 to 6 carbon atoms or by aryl radicals having from 6 to 12 carbon atoms. The choice of the radicals is also guided by the accessibility to the corresponding molecules, which are the substituted fluorenes, because the latter are commercially available or can be easily synthesized.

Mention may more particularly be made, as substituted fluorenyl groups, of the 2,7-di(tert-butyl) fluorenyl and 3,6-di(tert-butyl) fluorenyl groups. The 2, 3, 6 and 7 positions respectively denote the position of the carbon atoms of the rings as is represented in the diagram below, the 9 position corresponding to the carbon atom to which the bridge P is attached.

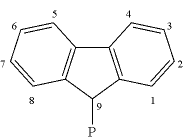

Preferably Cp¹ and CP² are identical. Advantageously, in the formula (II), Cp¹ and Cp² each represent the fluorenyl group. The fluorenyl group is of formula C₁₃H₈. Preferably, the metallocene is of formula (IIa), (IIb), (IIc), (IId) or (IIe), in which the symbol Flu presents the fluorenyl group of formula C₁₃H₈.

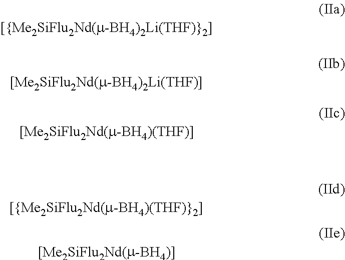

The organomagnesium compound used in the catalytic system as cocatalyst is a compound which exhibits at least one C—Mg bond. Mention may be made, as organomagnesium compounds, of diorganomagnesium compounds, in particular dialkylmagnesium compounds, and of organomagnesium halides, in particular alkylmagnesium halides. A diorganomagnesium compound is typically of formula MgR³R⁴ in which R³ and R⁴, which are identical or different, represent a carbon-based group. The term “carbon-based group” is understood to mean a group which contains one or more carbon atoms. Preferably, R³ and R⁴ contain from 2 to 10 carbon atoms. More preferentially, R³ and R⁴ each represent an alkyl. The organomagnesium compound is advantageously a dialkylmagnesium compound, better still butylethylmagnesium or butyloctylmagnesium, even better still butyloctylmagnesium.

The catalytic system can be prepared conventionally by a process analogous to that described in Patent Application WO 2007054224. For example, the organomagnesium compound and the metallocene are reacted in a hydrocarbon solvent typically at a temperature ranging from 20° C. to 80° C. for a period of between 5 and 60 minutes. The catalytic system is generally prepared in an aliphatic hydrocarbon solvent, such as methylcyclohexane, or an aromatic hydrocarbon solvent, such as toluene.

The metallocene used for preparing the catalytic system can be in the form of a crystalline or non-crystalline powder, or else in the form of single crystals. The metallocene can be provided in a monomer or dimer form, these forms depending on the method of preparation of the metallocene, as for example is described in Patent Application WO 2007054224. The metallocene can be prepared conventionally by a process analogous to that described in Patent Application WO 2007054224, in particular by reaction, under inert and anhydrous conditions, of the salt of an alkali metal of the ligand with a rare earth metal borohydride in a suitable solvent, such as an ether, for example diethyl ether or tetrahydrofuran, or any other solvent known to a person skilled in the art. After reaction, the metallocene is separated from the reaction by-products by techniques known to a person skilled in the art, such as filtration or precipitation from a second solvent. The metallocene is finally dried and isolated in solid form.

A person skilled in the art adjusts the molar ratio of the organomagnesium compound to the Nd metal constituting the metallocene according to the desired molar mass of the copolymer. The molar ratio can reach the value of 100, it being known that a molar ratio of less than 10 is more favourable for obtaining polymers of high molar masses.

Like any synthesis carried out in the presence of an organometallic compound, the synthesis of the metallocene and that of the catalytic system take place under anhydrous conditions in an inert atmosphere. Typically, the reactions are carried out starting from anhydrous solvents and compounds under anhydrous nitrogen or argon. In particular, the solvents are generally purified, for example in a known way by distillation, by treatment on alumina columns, by bubbling with an inert gas, such as nitrogen or argon, or by treatment with an organometallic compound, such as an organolithium compound, an organomagnesium compound or an organoaluminium compound.

The catalytic system is generally introduced into the reactor containing the polymerization solvent and the monomers.

The catalytic system can be prepared conventionally by a process analogous to that described in Patent Application WO 2007054224. For example, the organomagnesium compound and the metallocene are reacted in a hydrocarbon solvent typically at a temperature ranging from 20° C. to 80° C. for a period of between 5 and 60 minutes. The catalytic system is generally prepared in an aliphatic hydrocarbon solvent, such as methylcyclohexane, or an aromatic hydrocarbon solvent, such as toluene. Generally, after its synthesis, the catalytic system is used in this form in the process for synthesis of the copolymer in accordance with the invention.

Alternatively, the catalytic system can be prepared by a process analogous to that described in Patent Application WO 2017093654 A1 or in Patent Application WO 2018020122 A1. According to this alternative, the catalytic system additionally contains a preformation monomer chosen from a conjugated diene, ethylene or a mixture of ethylene and of a conjugated diene, in which case the catalytic system is based at least on the metallocene, the organomagnesium compound and the preformation monomer. For example, the organomagnesium compound and the metallocene are reacted in a hydrocarbon solvent typically at a temperature of from 20° C. to 80° C. for 10 to 20 minutes, in order to obtain a first reaction product, and then the preformation monomer, chosen from a conjugated diene, ethylene or a mixture of ethylene and of a conjugated diene, is reacted with this first reaction product at a temperature ranging from 40° C. to 90° C. for 1 h to 12 h. The catalytic system thus obtained can be used immediately after its synthesis in the process for synthesis of the copolymer in accordance with the invention or can be stored under an inert atmosphere, in particular at a temperature ranging from −20° C. to ambient temperature (23° C.), before its use in the process for the synthesis of the copolymer in accordance with the invention.

A person skilled in the art also adapts the polymerization conditions and the concentrations of each of the reactants (constituents of the catalytic system, monomers) according to the equipment (tools, reactors) used to carry out the polymerization and the various chemical reactions. As is known to a person skilled in the art, the copolymerization and also the handling of the monomers, of the catalytic system and of the polymerization solvent(s) take place under anhydrous conditions and under an inert atmosphere.

The polymerization is preferably carried out in solution, in a continuous, semi-continuous or batch process. The polymerization solvent can be an aromatic or aliphatic hydrocarbon solvent. Mention may be made, as examples of polymerization solvents, of toluene and methylcyclohexane. The monomers can be introduced into the reactor containing the polymerization solvent and the catalytic system or, conversely, the catalytic system can be introduced into the reactor containing the polymerization solvent and the monomers. The monomers and the catalytic system can be introduced simultaneously into the reactor containing the polymerization solvent, in particular in the case of a continuous polymerization. The polymerization is typically carried out under anhydrous conditions and in the absence of oxygen, in the optional presence of an inert gas. The polymerization temperature generally varies within a range extending from 25° C. to 120° C., preferably from 30° C. to 100° C.

During the polymerization of the ethylene and of the 1,3-butadiene in a polymerization reactor, ethylene and 1,3-butadiene can be added continuously to the polymerization reactor, in which case the polymerization reactor is a fed reactor. This embodiment is very particularly suitable for the synthesis of statistical copolymers.

The polymerization can be stopped by cooling the polymerization medium or by addition of an alcohol, preferentially an alcohol containing from 1 to 3 carbon atoms, for example ethanol. The polymer can be recovered according to conventional techniques known to a person skilled in the art, for example by precipitation, by evaporation of the solvent under reduced pressure or by steam stripping.

The copolymer in accordance with the invention is added to a mineral base oil in order to increase its viscosity index and to form a lubricating composition suitable for the envisaged use.

Mention may be made, as mineral base oils which may be suitable, of Group I base oils, Group II base oils and Group Ill base oils, Groups I to Ill being defined according to the American Petroleum Institute (API) in its publication “API No. 1509 Engine oil Licensing and Certification System, Appendix E, 14th Edition” of December 1996.

The content of copolymer in accordance with the invention added to a mineral base oil is adjusted by a person skilled in the art according to the nature of the mineral base oil, according to the characteristics of the copolymer, such as its content of ethylene units, its content of cyclohexane units and its number-average molar mass, and of course according to the use of the lubricating composition. The content of copolymer added to the mineral base oil can range up to 5% by weight of mineral base oil, for example from 0.01% to 5% by weight of mineral base oil, preferably from 0.05% to 2%.

The base oil to which a copolymer according to the invention has been added at a content adjusted by a person skilled in the art in order to obtain the desired thickening constitutes a lubricating composition which can furthermore contain other additives conventionally used in an engine oil, such as detergents and dispersants, antioxidants, compounds having an action against the formation of rust, of foam, of gel.

When added to a mineral base oil, the copolymers in accordance with the invention have the property of increasing its high temperature viscosity, like the copolymers of ethylene and of propylene commonly used as additives in engine oils. The copolymers according to the invention may prove to be even more effective as a high temperature thickener, typically at 100° C., than the copolymers of ethylene and of propylene generally containing at most 50 mol % of ethylene units, typically used as thickening additives for base oils. This is because, for one and the same amount added to a mineral base oil, the variation in viscosity is at least as great, indeed even greater, with a copolymer in accordance with the invention than with a copolymer of ethylene and of propylene. This increase in efficiency is attributed both to the high molar content of ethylene units and to the presence of 1,2-cyclohexane units in the copolymer in accordance with the invention.

The copolymer which contains a degree of crystallinity of between 35% and 45% according to one embodiment of the invention or a content of ethylene units ranging from 92% to 95% according to another particular embodiment of the invention also has the properties of a viscosity index improver (also known as a viscosity improver), since it increases the viscosity index of lubricating compositions. The viscosity improvers used in engine oils, such as poly(meth)acrylates and OCP polymers, have the ability to increase the high temperature viscosity, so as to counter the decrease in viscosity of the mineral base oil, without significantly increasing the low temperature viscosity. The selective action of viscosity improvers on the variation in the viscosity of mineral base oils with temperature improves the performance qualities of an engine oil which has to minimize, under cold conditions, the energy losses caused by frictional actions in the engine and to maintain, under hot conditions, a continuous film of lubricant on the lubricated components of the engine.

In summary, the invention is advantageously implemented according to any one of the following Embodiments 1 to 26:

Embodiment 1: Copolymer of ethylene and of 1,3-butadiene which contains ethylene units, butadiene units and 1,2-cyclohexane units and which exhibits a number-average molar mass of greater than 10 000 g/mol, the molar content of ethylene units in the copolymer being greater than 90% and less than or equal to 97%, the molar content of 1,2-cyclohexane units in the copolymer being greater than 1%, the molar contents being calculated with respect to the total number of moles of ethylene, butadiene and 1,2-cyclohexane units.

Embodiment 2: Copolymer according to Embodiment 1, in which the molar content of ethylene units is from 92% to 97%, preferentially from 92% to 96%.

Embodiment 3: Copolymer according to Embodiment 1 or 2, in which the molar content of ethylene units is from 92% to 95%.

Embodiment 4: Copolymer according to any one of Embodiments 1 to 3, in which the molar content of 1,2-cyclohexane units is greater than or equal to 2%.

Embodiment 5: Copolymer according to any one of Embodiments 1 to 4, in which the molar content of 1,2-cyclohexane units is less than 4%.

Embodiment 6: Copolymer according to any one of Embodiments 1 to 5, in which the molar content of butadiene units is greater than 1%.

Embodiment 7: Copolymer according to any one of Embodiments 1 to 6, in which the molar content of butadiene units is greater than or equal to 2%.

Embodiment 8: Copolymer according to any one of Embodiments 1 to 7, in which the molar content of butadiene units is less than 5%.

Embodiment 9: Copolymer according to any one of Embodiments 1 to 8, in which more than 30 mol % of the butadiene units are 1,2-units of formula —CH₂—CH(CH═CH₂)—.

Embodiment 10: Copolymer according to any one of Embodiments 1 to 9, which copolymer contains 1,4-units of formula —CH₂—CH═CH—CH₂— and more than 50% of the 1,4-units of formula —CH₂—CH═CH—CH₂— are of trans configuration.

Embodiment 11: Copolymer according to any one of Embodiments 1 to 10, which copolymer contains 1,4-units of formula —CH₂—CH═CH—CH₂— and more than 80% of the 1,4-units of formula —CH₂—CH═CH—CH₂— are of trans configuration.

Embodiment 12: Copolymer according to any one of Embodiments 1 to 11, which copolymer has a melting point of greater than or equal to 97° C.

Embodiment 13: Copolymer according to any one of Embodiments 1 to 12, which copolymer has a melting point of greater than 97° C.

Embodiment 14: Copolymer according to any one of Embodiments 1 to 13, which copolymer has a number-average molar mass of greater than 15 000 g/mol.

Embodiment 15: Copolymer according to any one of Embodiments 1 to 14, which copolymer has a number-average molar mass of greater than 20 000 g/mol.

Embodiment 16: Copolymer according to any one of Embodiments 1 to 15, which copolymer has a number-average molar mass of less than 200 000 g/mol.

Embodiment 17: Copolymer according to any one of Embodiments 1 to 16, which copolymer has a number-average molar mass of less than or equal to 150 000 g/mol.

Embodiment 18: Copolymer according to any one of Embodiments 1 to 17, which copolymer has a number-average molar mass of less than or equal to 130 000 g/mol.

Embodiment 19: Copolymer according to any one of Embodiments 1 to 18, which copolymer has a number-average molar mass of less than or equal to 100 000 g/mol.

Embodiment 20: Copolymer according to any one of Embodiments 1 to 19, which copolymer has a dispersity [symbol] of greater than 1 and less than 5.

Embodiment 21: Copolymer according to any one of Embodiments 1 to 20, which copolymer has a dispersity [symbol] of greater than 1 and less than 4.

Embodiment 22: Copolymer according to any one of Embodiments 1 to 21, which copolymer has a dispersity [symbol] of greater than 1 and less than 3.

Embodiment 23: Copolymer according to any one of Embodiments 1 to 22, which copolymer is a statistical copolymer.

Embodiment 24: Copolymer according to any one of Embodiments 1 to 23, which copolymer has a degree of crystallinity of greater than 35%.

Embodiment 25: Copolymer according to any one of Embodiments 1 to 24, which copolymer has a degree of crystallinity of between 35% and 50%.

Embodiment 26: Copolymer according to any one of Embodiments 1 to 25, which copolymer has a degree of crystallinity of between 35% and 45%.

A better understanding of the abovementioned characteristics of the present invention, and also of others, will be obtained on reading the following description of implementational examples of the invention, given by way of illustration and without limitation.

### EXAMPLES

### Determination of the Microstructure of the Polymers:

High resolution NMR spectroscopy of the polymers was carried out on a Bruker 600 Avance III HD spectrometer operating at 600 MHz equipped with a CP2.1 BBO 600S3 probe for the proton. The acquisitions are made at 368 K. ortho-dichlorobenzene (o-DCB) is used as solvent. The samples were analysed at a concentration of approximately 1% by weight for the proton NMR (1H NMR) analyses. The chemical shifts are determined relative to the proton signal of ortho-dichlorobenzene fixed at 7.2 ppm. A 2D analysis was performed using the following sequence: HSQC: Pulse program; hsqcetgpsi2 “HSQC with gradients”; SW1: 180 ppm (¹³C); SW2: 12 ppm (¹H); d1: 10 s; 90° “hard” pulse ¹H P1=13 μs and 16 W and ¹³C P2=26 μs and 84 W; Gradient: SMSQ10.100.

The determination of the microstructure of the copolymers is defined in the literature, according to the paper by Llauro et al., Macromolecules, 2001, 34, 6304-6311.

### Determination of the Macrostructure of the Polymers:

Size exclusion chromatography is used. It will be recalled that SEC makes it possible to separate macromolecules in solution according to their size through columns filled with a porous gel. The macromolecules are separated according to their hydrodynamic volume, the bulkiest being eluted first. Without being an absolute method, SEC makes it possible to understand the distribution of the molar masses of a polymer. The various number-average molar masses (Mn) and weight-average molar masses (Mw) can be determined from commercial standards and the dispersity ( [symbol] =Mw/Mn) can be calculated via a “Moore” calibration.

Preparation of the polymer: There is no particular treatment of the polymer sample before analysis. The latter is simply solubilized, in 1,2,4-trichlorobenzene containing 300 ppm of BHT (butylated hydroxytoluene), at a concentration of approximately 1 g/l. The solution is stirred at 160° C. for 2 h before injection and the chromatographic device used is equipped with an in-line filtration system.

SEC analysis: High temperature size exclusion chromatography or HT-SEC is used. The apparatus used is a GPC-IR chromatograph equipped with an IR-6 infrared detector from Polymer Char. Detection is carried out by the IR detector on the vibration bands of the CH₂ and CH₃ groups. A set of 3 “Mixed BN-LS” commercial reference columns from Polymer Char is used. The elution solvent is 1,2,4-trichlorobenzene containing 300 ppm of BHT, the flow rate is 1 ml/min, the temperature of the system is 160° C. and the analytical time is 90 minutes (min).

The volume injected of the solution of the polymer sample is 200 μl. The software for making use of the chromatographic data is the GPC-one system from Polymer Char.

The average molar masses are determined from a calibration curve produced from PSS Ready Cal-Kit commercial polystyrene standards.

Determination of the Degree of Crystallinity of the Polymers and of their Melting Point:

The degree of crystallinity and the melting point are determined by differential scanning calorimetry (DSC). The analyses are carried out on a Netzsch DSC 214 Polyma DSC device calibrated with indium. This device has available a temperature range extending from −150° C. to 700° C. A computer integrated into the DSC controls the device using the Proteus software from Netzsch. The sample (approximately 10 mg) is weighed and sealed in a 40 μl aluminium crucible. The crucible is pierced with a fine needle just before the measurement. The samples are analysed under helium at 40 ml/min according to a dynamic method comprising 7 temperature steps:

Step 1: cooling from 25° C. to −150° C. at 50° C./min; Step 2: isothermal at −150° C. for 5 min; Step 3: heating from −150° C. to 200° C. at 20° C./min; Step 4: isothermal at 200° C. for 5 min; Step 5: cooling from 200° C. to −150° C. at 20° C./min; Step 6: isothermal at −150° C. for 5 minutes; Step 7: heating from −150° C. to 200° C. at 20° C./min.

The first four steps make it possible to erase the thermal history of the sample. The measurements of the melting point (Tm) are carried out on the 7th step. The 7th step is also retained in order to obtain information on the crystallization of the sample and to determine the degree of crystallinity.

The Tm values are determined by applying the data reprocessing of the Proteus software from Netzsch. The degree of crystallinity is determined by using Standard ISO 11357-3:2011 to measure the temperature and enthalpy of fusion and crystallization of the polymers used by differential scanning calorimetry (DSC). The reference enthalpy of polyethylene is 293 J/g (source: B. Wunderlich, Thermal Analysis, Academic Press, 1990, 281).

### Determination of the Viscosity of the Lubricating Compositions:

The viscosity results are presented in base 100 with respect to a control. The control consists of the same base oil which is used in the lubricating compositions. The kinematic viscosities at 100° C. and the viscosity index are determined according to Standard ASTM 445-21 and ASTM D2270.

### Preparation of the Copolymers of Ethylene and of 1,3-Butadiene:

The copolymers are prepared according to a semi-continuous process, that is to say a “fed batch” process. Ethylene and 1,3-butadiene are introduced into an 80 litre reactor containing methylcyclohexane (60 litres) and heated to 100° C. according to a ratio by weight given in Table 1 until 6 bar of pressure are reached in the reactor maintained at 100° C. A 0.88 mol/l solution of butyloctylmagnesium (BOMAG) in methylcyclohexane is injected into the reactor, followed by the catalytic system (2.66 mmol equivalent of Nd, i.e. 1.7 g of catalytic system). The reaction temperature is regulated at a temperature of 100° C., the pressure in the reactor increases to 8 bar, and the polymerization reaction starts. The polymerization reaction takes place at a constant pressure of 8 bar. The reactor is fed with ethylene and with 1,3-butadiene throughout the polymerization reaction according to the given ratio by weight of ethylene and of 1,3-butadiene. The conditions for each of the syntheses of the polymers appear in Table 1, in particular the ratio by weight of ethylene and of 1,3-butadiene and the amount of BOMAG solution.

The catalytic system is a preformed catalytic system. It is prepared in methylcyclohexane from a metallocene, [Me₂Si(Flu)₂Nd (μ-BH₄)₂Li(THF)] at 0.0065 mol/l, from a cocatalyst, butyloctylmagnesium (BOMAG), the BOMAG/Nd molar ratio of which is equal to 2.2, and from a preformation monomer, 1,3-butadiene, the 1,3-butadiene/Nd molar ratio of which is equal to 90. The medium is heated at 80° C. over a period of 5 h. It is prepared according to a preparation method in accordance with section II.1 of Patent Application WO 2017093654 A1.

All the reactants are obtained commercially except for the metallocene of formula [{Me₂SiFlu₂Nd(μ-BH₄)₂Li(THF)}₂], which can be prepared according to the procedure described in the document WO 2007054224. The butyloctylmagnesium BOMAG (20% by weight in heptane, C=0.88 mol·l⁻¹) originates from Lanxess and is stored in a metal cylinder under an inert atmosphere. The ethylene, of N35 grade, originates from Air Liquide and is used without prior purification. The 1,3-butadiene is purified over alumina guards. The methylcyclohexane solvent originating from BioSolve is dried and purified on an alumina column in a solvent purifier originating from mBraun and used in an inert atmosphere. All the reactions are carried out in an inert atmosphere.

The conversion of the polymerization reaction is measured by solids content and, when the weight of 6 kg of polymer is reached, the injection of the monomers into the reactor is stopped. 152 ml of 1 mol/l ethanol are injected to stop the polymerization reaction. 226 ml of 218 g/l Irganox 1520L, an antioxidant, are injected into the reactor. The contents of the reactor are transferred into another reactor called a “stripping reactor” to remove the solvent by steam distillation while maintaining a temperature of 100° C. The copolymer is recovered and then dried in an oven at 60° C. for 48 hours under vacuum and flushing with nitrogen.

The weighed mass of copolymer makes it possible to determine the mean catalytic activity of the catalytic system, expressed in kilograms of polymer synthesized per mole of neodymium metal and per hour (kg/mol·h).

The macrostructure characteristics of the polymers appear in Table 1 and the microstructure characteristics, as well as the melting point and the degree of crystallinity, appear in Table 2. The content of the units is expressed as molar percentage, calculated with respect to the total number of moles of ethylene, butadiene and 1,2-cyclohexane units.

TABLE 1

| | Butadiene/ethylene | | | | | |
|---|---|---|---|---|---|---|
| | ratio by weight | BOMAG | Activity | | Mn (SEC) | |
| Example | (g/g) | (ml) | kg/mol/h | Polymer | g/mol | Ð |
| 1 | 0.14 | 182 | 984 | Poly 1 | 13 500 | 2.2 |
| 2 | 0.14 | 67.5 | 981 | Poly 2 | 20 200 | 2.3 |
| 3 | 0.14 | 36.9 | 1211 | Poly 3 | 72 800 | 2.0 |
| 4 | 0.09 | 182 | 1457 | Poly 4 | 12 800 | 2.4 |
| 5 | 0.09 | 67.5 | 1503 | Poly 5 | 18 100 | 2.3 |

TABLE 2

| | | 1,2- | | | | |
|---|---|---|---|---|---|---|
| | Ethylene | Cyclohexane | 1,2- | 1,4- | Tm | Crystallinity |
| Polymer | unit | unit | units | units | (° C.) | (%) |
| Poly 1 | 93.7 | 3.4 | 1.4 | 1.5 | 99 | 43 |
| Poly 2 | 93.4 | 3.8 | 1.3 | 1.5 | 100 | 41 |
| Poly 3 | 92.7 | 3.2 | 2.6 | 1.5 | 97 | 37 |
| Poly 4 | 95.8 | 2.2 | 1.1 | 0.9 | 116 | 46 |
| Poly 5 | 95.0 | 2.8 | 1.1 | 1.1 | 116 | 39 |

### Preparation of the Lubricating Compositions Containing a Base Oil 100 or 600:

Twelve lubricating compositions are prepared according to the following procedure:

1 g of polymer is introduced into a 250 ml steinie bottle containing 200 g of a base oil. The steinie bottle is capped and stirred in a thermostatically controlled bath at 90° C. for 12 hours. The viscosity of the resulting mixture is measured at 100° C. The polymers are the polymers Poly 1, Poly 2, Poly 3, Poly 4 and Poly 5, and also an OCP polymer sold by Lubrizol under the reference 7077, a copolymer of ethylene and of propylene having approximately 50 mol % of ethylene and a degree of crystallinity of 2.3%.

Each of the compositions C1 to C5 and C7 to C11 contains a base oil and a copolymer in accordance with the invention. The base oil of the compositions C1 to C5 is a base oil 600 and that of the compositions C6 to C11 is a base oil 100. The compositions C0 and C6, respectively containing a base oil 600 and 100, are reference compositions, since they additionally contain a copolymer not in accordance with the invention, the copolymer 7077 from Lubrizol, an additive commonly used in engine oils as high temperature (100° C.) thickening agent. The base oils Core™ 600 and Core™ 100 sold by Exxon are Group I mineral base oils and are commonly used as base oil in engine oils.

The results for viscosities are presented in Tables 3 and 4 in base 100 with respect to a control. The control for the lubricating compositions C0 to C5 is the lubricating composition T1, which corresponds to the base oil 600 alone. The control for the lubricating compositions C6 to C11 is the lubricating composition T2, which corresponds to the base oil 100 alone.

TABLE 3

| Lubricating | | | | | | | |
|---|---|---|---|---|---|---|---|
| composition | T1 | C0 | C1 | C2 | C3 | C4 | C5 |
| Base oil | 600 | 600 | 600 | 600 | 600 | 600 | 600 |
| Polymer | — | OCP | Poly 1 | Poly 2 | Poly 3 | Poly 4 | Poly 5 |
| Viscosity at 100° C. | 100 | 103 | 108 | 108 | 111 | 103 | 106 |

TABLE 4

| Lubricating | | | | | | | |
|---|---|---|---|---|---|---|---|
| composition | T2 | C6 | C7 | C8 | C9 | C10 | C11 |
| Base oil | 100 | 100 | 100 | 100 | 100 | 100 | 100 |
| Polymer | — | OCP | Poly 1 | Poly 2 | Poly 3 | Poly 4 | Poly 5 |
| Viscosity at 100° C. | 100 | 105 | 110 | 115 | 132 | 107 | 113 |
| Viscosity index | 96 | 103 | 96 | 119 | 150 | 50 | 107 |

It is observed that the lubricating compositions containing a copolymer in accordance with the invention (C1 to C5 and C7 to C11) have a viscosity at 100° C. which is greater than that of the base oil which they contain (respectively T1 and T2). Moreover, it is noted that the viscosities of the compositions C1 to C5 and C7 to C11 are at least equal to or greater than those of the respective reference compositions C0 and C6. This result is obtained even though the copolymers according to the invention have a number-average molar mass which is much lower than that of the OCP copolymer. Surprisingly, as high temperature thickening agent for mineral base oils, the copolymers according to the invention prove to be as effective, indeed even more effective, than an OCP copolymer.

It is also observed that the use of the copolymers Poly 1, Poly 2, Poly 3 and Poly 5 in an engine oil containing a base oil 100 has the advantage not only of increasing the high temperature viscosity but also of having a selective action on the increase in the viscosity with temperature. This is because the viscosity index of the lubricating compositions C7, C8, C9 and C11 is at least as high as that of the control composition T2 or higher than that of the reference composition C6. Surprisingly, the copolymers according to the invention having an ethylene content ranging from 92% to 95% also have the property of selective high temperature viscosity improver.

What is claimed is:

1. A copolymer of ethylene and of 1,3-butadiene which contains ethylene units, butadiene units and 1,2-cyclohexane units and which exhibits a number-average molar mass of greater than 10 000 g/mol, the molar content of ethylene units in the copolymer being greater than 90% and less than or equal to 97%, the molar content of 1,2-cyclohexane units in the copolymer being greater than 1%, the molar contents being calculated with respect to the total number of moles of ethylene, butadiene and 1,2-cyclohexane units.

2. The copolymer according to claim 1, in which the molar content of ethylene units is from 92% to 97%, preferentially from 92% to 96%.

3. The copolymer according to claim 1, in which the molar content of ethylene units is from 92% to 95%.

4. The copolymer according to claim 1, in which the molar content of 1,2-cyclohexane units is greater than or equal to 2%.

5. The copolymer according to claim 1, in which the molar content of 1,2-cyclohexane units is less than 4%.

6. The copolymer according to claim 1, in which the molar content of butadiene units is greater than 1%, preferentially greater than of equal to 2%.

7. The copolymer according to claim 1, in which the molar content of butadiene units is less than 5%.

8. The copolymer according to claim 1, in which more than 30 mol % of the butadiene units are 1,2-units of formula —CH₂—CH(CH—CH₂)—.

9. The copolymer according to claim 1, which copolymer has a melting point of greater than or equal to 97° C., preferably of greater than 97° C.

10. The copolymer according to claim 1, which copolymer has a number-average molar mass of greater than 15 000 g/mol.

11. The copolymer according to claim 1, which copolymer has a number-average molar mass of greater than 20 000 g/mol.

12. The copolymer according to claim 1, which copolymer has a number-average molar mass of less than 200 000 g/mol; preferentially of less than or equal to 150 000 g/mol.

13. The copolymer according to claim 1, which copolymer has a number-average molar mass of less than or equal to 130 000 g/mol; preferentially of less than or equal to 100 000 g/mol.

14. The copolymer according to claim 1, which copolymer is a statistical copolymer.

15. The copolymer according to claim 1, which copolymer has a degree of crystallinity of greater than 35%.

16. The copolymer according to claim 2, in which the molar content of ethylene units is from 92% to 96%.

17. The copolymer according to claim 6, in which the molar content of butadiene units is greater than or equal to 2%.

18. The copolymer according to claim 9, which copolymer has a melting point of greater than 97° C.

19. The copolymer according to claim 12, which copolymer has a number-average molar mass of less than or equal to 150 000 g/mol.

20. The copolymer according to claim 13, which copolymer has a number-average molar mass of less than or equal to 100 000 g/mol.
